(19) United States
(12) Patent Application Publication
(10) Pub. No.: US 2005/0214082 A1
(43) Pub. Date: Sep. 29, 2005

(54) Lubricants in cutting tools for dry machining

(76) Inventor: Jean M. Dasch, Bloomfield, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/806,679

(22) Filed: Mar. 23, 2004

(51) Int. Cl. B23B 51/06

(52) U.S. Cl. 408/59

(57) ABSTRACT

Workpiece cutting tools, such as drills, are often provided with through holes that preferably extend from the cutting end of the tool along its length to the holding end. In accordance with this invention, such through holes of a cutting tool are filled with a lubricating oil-in a thermoplastic polymer matrix by injection or molding of the mixture into the holes. In the operation of the tool, the oil thus stored within the tool flows in the polymer matrix to the cutting site to reduce cutting power requirements and wear of the tool. Through the use of such cutting tools, the use of metal removal fluids can be eliminated and dry machining facilitated.

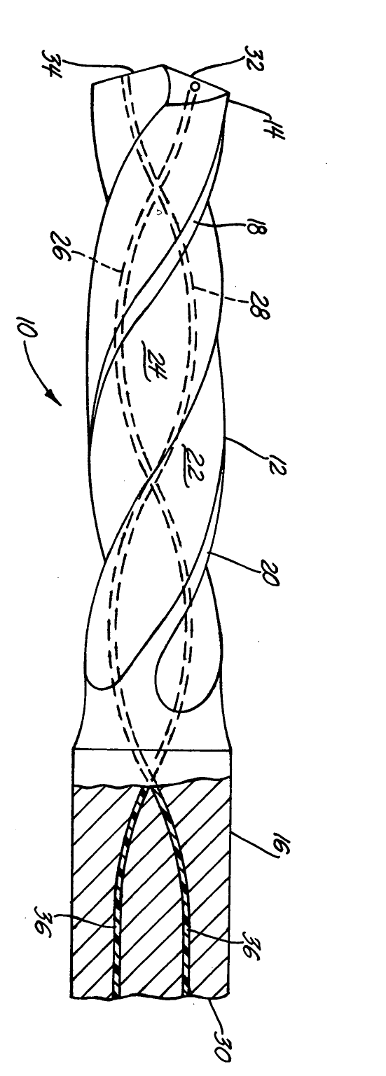

### TECHNICAL FIELD

This invention pertains to cutting tools, such as drills, containing a dry lubricant. More specifically, this invention pertains to cutting tools with through holes containing an oil-filled polymer lubricant for delivery of lubricating oil to the cutting site during machining operation.

### BACKGROUND OF THE INVENTION

Cutting tools, such as drills, reamers, taps and boring bars, are widely used in metal removal (machining) operations for making articles of manufacture. In sophisticated manufacturing operations, such as in machining centers using computer numerical controls, the cutting tool is clamped in a toolholder which in turn is secured in the spindle of a machine tool. The machine tool locates and powers the cutting tool against a workpiece for the cutting operation. Usually, a lubricating and cooling fluid, known as a metal removal fluid (MRF), is applied through nozzles onto the part being machined in a flood application. In situations where the MRF needs to reach the cutting edge of the tool, it is pumped through one or more holes (through holes) running the length of the tool. The MRF is maintained in a suitable reservoir and pumped through the spindle and toolholder into the through hole openings at the clamped end of the tool. The pressurized MRF flows through the holes to the cutting end of the tool and floods the cutting site.

MRFs consist of the lubricant emulsified in water (1:20 ratio, typically) and large volumes are used to cool and lubricate and to remove metal chips. Eventually, the used, metal-particle-containing material must be disposed of in a suitable manner. In a large machining center the volume of such liquid materials can be substantial, requiring processing and treatment infrastructure for suitable management and disposal of the waste material. Such costs and issues have spurred research into “dry machining” without the use of MRFs.

Toward the goal of dry machining, it is the object of this invention to provide a drill or reamer, tap, boring bar, or like cutting tool, in which through holes, such as those previously used for delivery of a liquid coolant/lubricant from a machining center reservoir, are filled with a dry lubricant, and the limited volume of dry lubricant serves in cutting operations until the dry lubricant is expended and the tool is refurbished or recycled.

### SUMMARY OF THE INVENTION

The practice of the invention will be illustrated with respect to a drill with the understanding that the invention can be applied to reamers, taps, boring bars, and the like.

Drills are typically metal (or metal carbide) rods having a suitable length and diameter for a specified metal cutting operation. The drill rod has a main body portion with a cutting end and an opposite end for clamping with a toolholder. The round body of the drill often has twisted longitudinal rounded grooves, called flutes, leading from the cutting end toward the clamping end. The cutting end has hard, sharp cutting edges for abrading chips from a metal workpiece as the cutting edges are pressed against the workpiece and the drill is rotated at a suitable velocity. As the cutting end of the drill penetrates the workpiece, chips are removed from the workpiece and carried through the helical flutes along the length of the drill away from the cutting site.

In accordance with the invention, one or more longitudinal holes are required in the drill. These holes extend from the surface of the cutting end to, or toward, the opposite end of the drill rod. But the hole is open to the atmosphere at both of its ends. The hole(s) are initially filled with a porous solid/lubricating oil mixture. The consistency of the mixture is such that it remains in the hole(s) in the drill when the tool is not in use. When the drill is working, oil flows from the porous solid matrix to the cutting site to provide lubrication and cooling as the cutting surfaces of the tool abrade material from the workpiece. The source of such lubrication material is limited to the volume initially retained in the hole(s) of the drill. No additional volume or reservoir of coolant or lubricant is contemplated for use in the operation of the drill during its useful life before it is refurbished and the lubricant replaced.

Oil-filled polymer lubricants are an example of a suitable material for use in the “dry” lubricated cutting tools of this invention. The polymer constituent is suitably a thermoplastic olefin polymer that typically makes-up about 20-50% by weight of the mixture. The oil constituent is suitably a hydrocarbon-based liquid, an ester-based oil or other lubricant oil that can be mixed and molded with a polyethylene of suitable molecular weight (for example, a molecular weight of about 200,000 to about 700,000) with or without processing additives. The polymer and oil are mixed and injected into the through holes of the cutting tools. Typically it is necessary to heat the polymer/oil mixture at some stage to better disperse the oil in the polymer matrix. Depending upon the specific polymer/oil constituents and the tool application such heating may be done before or after the mixture has been inserted into the through holes of the tool. During machining, sufficient heat is generated to initiate capillary release of the lubricant from the polymer matrix. Processing additives may be employed to facilitate the mixing of the polymer and oil and the release of the oil from the polymer matrix after molding in the holes of the tools. MicroPoly, a trademarked product of PhyMet, Inc.; Springboro, Ohio is an example of an oil-filled polymer mixture suitable for use in the subject cutting tools.

In many cutting operations the removal of machining chips will be best facilitated when the tool has helical or twisted flutes that propel the chips from the cutting site as the tool is being rotated. Dry machining operations, which are enabled by this invention, do not employ high volume, high pressure MRFs for chip removal.

Tests have been conducted comparing an unfilled drill with a dry lubricant filled drill for boring holes in an aluminum alloy workpiece. The dry lubricant filled drill operated with lower power consumption, lower vibration, lower noise, and performed longer and cleaner than an unfilled drill. Such an oil-filled polymer lubricated drill provides a workable drilling function in many metal removal applications and can avoid the use and management of larger volumes of liquid coolant/lubricants.

Other objects and advantages of the invention will become more apparent from a detailed description of a preferred embodiment which follows.

### BRIEF DESCRIPTION OF THE DRAWINGS

The drawing FIGURE is a side elevation view, partially in cross section, of a drill with two helical twist flutes. In accordance with the invention an oil-filled polymer lubricant fills helical through-holes along the length of the drill.

### DESCRIPTION OF PREFERRED EMBODIMENTS

Cutting tools are usually formed from a round bar of metal having a length and diameter specified by the intended application. In the drawing FIGURE, drill 10 is constructed of a body section 12, a cutting head end 14 and a mounting end 16. A collet, not shown, may be attached to the mounting end 16 for securing of the drill 10 in a suitable toolholder. In this example, drill 10 has helical twist lands 18 and 20. Helical twist longitudinal flutes 22 and 24 are cut between lands 18 and 20 and provide channels for chip removal during a cutting operation. Also, in this example, body section 12 and cutting head end 14 are formed of the same material so there is not a definite interface between them. Lands 18 and 20 and flutes 22 and 24 extend from cutting head end 14 along body section 12 and terminate at mounting end 16. In some cutting tool embodiments the body and mounting portions of the tool may be made, for example, of tool steel while the cutting head is made of a harder material such as tungsten carbide. In such an embodiment, there would be an interface between cutting head end 14 and shank section 12 and their respective lands and flutes that is not seen in the FIGURE.

Two through holes 26 and 28 extend the whole length of drill 10 from the end 30 of mounting portion 16 to the cutting faces 32 and 34 of cutting head end 14. In prior drills such through holes have been used for the delivery of a liquid coolant/lubricant through the drill to the workpiece cutting site. The liquid coolant is maintained in a suitable reservoir apart from the cutting tool and delivered under high pressure through a machine tool spindle to the toolholder. But, in the practice of this invention, through holes 26 and 28 are formed and sized for holding a volume of oil-filled polymer material 36 for the lubrication of the cutting site/cutting faces 34, 36 interfaces.

Initially, through holes 26, 28 are injected or otherwise filled with a moldable slurry or mixture of thermoplastic polymer/lubrication oil/additive mixture 36. At some point in its processing the mixture may have been heated to disperse the oil and any additives in the polymer matrix. Depending upon the specific constituents of the mixture such heating may occur before or after the mixture is injected into holes 26, 28. Through holes 26, 28 are thus filled with an oil-containing solid mass 36 along the full length of each of the through holes 26 and 28. The portion of the oil-filled polymer material 36 at the cutting faces 32 and 34 of cutting head end 14 is available to provide oil at the working face of the tool when the tool is operated on a workpiece. As oil is wiped or otherwise removed from the worksite more oil is exuded by the polymer matrix down the length of each through hole 28, 30 to cutting faces 32, 34 and the work site. A reservoir other than the material in through holes 26 and 30 is optional but not required. It is intended that the oil-filled material 36 in the through holes 26, 28 of the cutting tool 10 suffice during the useful life of the tool.

Oil-filled polymer lubricants suitable for the practice of this invention are commercially available. For example, such lubricants are offered under designations such as MPI-0800, MPI-2000, or MPI-2400 by PhyMet, Inc. They are moldable materials often containing more than 50% by weight of lubricating oil in a thermoplastic polymer matrix. Suitable matrix materials include, for example, polyethylene and mixtures of polyethylene with polypropylene. The mixtures are typically molded into a suitable bearing structure for lubrication of moving machine parts in frictional engagement. The molded bearing is shaped to provide an abundant polymer matrix surface for suitable delivery of the oil contained in the micro pores of the matrix. However, in the practice of this invention, the material or its precursor is mixed and injected into a through hole of a cutting tool. The through hole is filled from the cutting surface of the tool to a level in the hole for a suitable supply of lubrication oil. Generally, it is expected that the through hole(s) of the cutting tool will be filled with the oil-filled lubricant.

The polymer matrix material is thermoplastic material such as polyethylene of a molecular weight suitable for injection and molding into the through holes of a cutting tool. The polymer is mixed with a suitable oil such as a hydrocarbon oil, or a polyester oil, or the like. Oils may be blended for better release or lubrication properties. The oil and polymer are mixed and molded so that the oil fills, and is temporarily stored in, the very small pores between polymer chains. The polymer and oil mixture may also contain additives for modifying the interaction between the polymer matrix and the storage and release of the specific oil. And the mixture may contain suitably small particles of dry lubricant materials such as graphite or molybdenum disulfide. U.S. Pat. No. 5,435,925 to Jamison, and entitled “Polyethylene Lubricant-Dispensing Compositions,” describes oil-filled polymer lubricating materials suitable for use in the cutting tool practices of this invention.

Comparative cutting tests were conducted with two twisted flute drills. Each drill was ½ inch in diameter and had three helical flutes and intervening lands. A helical through hole extended the full length of each drill in each land portion. The length of each drill was 5.5 inches and the diameter of each through hole was 0.063 inch. The three through holes in one drill were filled with MicroPoly MPI-0800 oil-filled lubricant by injecting it into the helical holes of the drill. In this case the polymer/oil mixture was heated after loading into the through holes. The lubricated and un-lubricated drills were used to drill holes in a cast aluminum alloy 319 workpiece. AA319 is a silicon containing, aluminum casting alloy sometimes used in making cylinder blocks and cylinder heads for automotive engines. Each drill was used to drill twelve holes in the same workpiece.

The un-lubricated drill soon became totally clogged with aluminum from the workpiece while the cutting face of the lubricated drill remained clean.

During drilling, the power draw was monitored for each drill. The MicroPoly dry lubricant filled drill consistently required a less than four horsepower power draw for each of the twelve holes in the AA319 alloy. But the power requirements of the unfilled drill increased from nearly six horsepower for the first hole drilled to about nine to thirteen horsepower for holes 4-12. The continuous release of lubricant from the drill containing the oil-filled polymer significantly reduced the power requirements for such dry machining.

Other machining characteristics of the drills were monitored during the drilling of the identical holes in the same workpiece material. The following table summarizes power, force, torque, vibration and acoustic emission levels for the lubricant filled drill and the drill with no lubricant filling.

Average Machining parameters with and without MicroPoly (½″ drill, 12 holes)

| | Power | Force | Torque | | Acoustic |
|---|---|---|---|---|---|
| | HP | lbs | lb-in | Vibration | Emission |
| No filling | 7.28 | 318 | 61 | 1.0 | 0.71 |
| Filling | 3.67 | 265 | 37 | 0.53 | 0.54 |

The oil in the solid lubricant containing drill clearly decreased the power requirements of the cutting operation. It also reduced the vibration of the drill for dimensional accuracy.

The practice of invention has been illustrated with the example of drills. But the invention is applicable to other cutting tools in applications where an oil lubricant is suitable for the machining operation. Accordingly, the invention is applicable to other cutting tools such as reamers, taps and boring tools.

1. A cutting tool for rotational cutting engagement under pressure with a workpiece surface, said cutting tool comprising;
a rod-shaped body having a cutting portion with a cutting surface at one end of said body and an attachment portion at the other end of said body;
at least one hole within said body extending along the length of said body from a first outlet at said cutting surface to a second outlet from said body; and
an oil-filled polymer lubricant in said hole at said cutting surface of said first outlet, said lubricant releasing oil at said cutting surface in operation of said tool.

2. The cutting tool as recited in claim 1 in which a volume of said lubricant is filled in said hole before use of said cutting tool and said volume is the sole source of lubricant at said cutting surface in the operation of said cutting tool.

3. The cutting tool as recited in claim 1 in which said tool is a drill and said hole extends in a helical path along the longitudinal axis of said body of said drill to a second outlet at the connecting end of said body.

4. The cutting tool as recited in claim 1 in which said oil-filled polymer lubricant comprises a microporous polyethylene matrix containing lubricating oil and said oil makes up more than 50% by weight of said lubricant in said tool.

5. A drill for rotational cutting engagement under pressure with a workpiece surface, said drill comprising;
a rod-shaped body having a cutting portion with a cutting surface at one end of said body, an attachment portion at the other end of said body and at least one helical flute in said body extending from said cutting surface;
at least one hole within said body extending along the length of said body from a first outlet at said cutting surface to a second outlet from said body; and
an oil-filled polymer lubricant in said hole at said cutting surface of said first outlet, said lubricant releasing oil at said cutting surface in operation of said tool.

6. A drill as recited in claim 5 in which said hole extends in a helical path along the longitudinal axis of said body of said drill to a second outlet at the connecting end of said body.

7. The drill as recited in claim 5 in which a volume of said lubricant is filled in said hole before use of said drill and said volume is the sole source of lubricant at said cutting surface in the operation of said drill.

8. The drill as recited in claim 5 in which said oil-filled polymer lubricant comprises a microporous polyethylene matrix containing lubricating oil and said oil makes up more than 50% by weight of said lubricant in said drill.
